(19) United States
(12) Patent Application Publication
(10) Pub. No.: US 2012/0308837 A1
(43) Pub. Date: Dec. 6, 2012

(54) Process for the generative preparation of ceramic shaped bodies by 3D inkjet printing

(75) Inventors: Nadja SCHLECHTRIEMEN, Feldkirch (AT); Jürgen LAUBERSHEIMER, Buchs (CH); Volker RHEINBERGER, Vaduz (LI)

(73) Assignee: IVOCLAR VIVADENT AG, Schaan (LI)

(21) Appl. No.: 13/482,701

(22) Filed: May 29, 2012

(30) Foreign Application Priority Data
May 31, 2011 (EP) 11168182.1

(51) Int. Cl. B29C 35/08; B32B 18/00; B32B 1/00; B05C 5/02

(52) U.S. Cl. 428/446; 264/610; 118/46; 264/401

(57) ABSTRACT

Process for the generative preparation of a shaped body in which (a) ceramic slips are applied in layers to a support and cured, (b) a further layer is applied to the cured layer from step (a) and cured, (c) step (b) is repeated until a body with the desired geometric shape is obtained, (d) the body is then subjected to a chemical treatment or a heat treatment to remove the binding agent (debindering), and (e) the body from step (d) is sintered, wherein at least two differently composed ceramic slips are used in steps (a) and (b) for the preparation of the layers.

### CROSS-REFERENCE TO RELATED APPLICATIONS

This application claims the benefit of EP 11168182 filed May 31, 2011, which is hereby incorporated by reference in its entirety.

### TECHNICAL FIELD

The present invention relates to a process for the preparation of ceramic shaped parts and in particular to the preparation of dental restorations by three-dimensional printing.

### BACKGROUND

So-called “constructive processes” are increasingly being used for the preparation of shaped bodies. The term “generative manufacturing processes” is often used as a synonym for these “constructive” possibilities. These terms cover various generative manufacturing processes in which 3-dimensional models or components are prepared from computer-aided design data (CAD data) (A. Gebhardt, Vision of Rapid Prototyping, Ber. DGK 83 (2006) 7-12), which is hereby incorporated by reference. Examples of typical generative manufacturing processes are stereolithography, 3D printing and inkjet modelling. The principle of rapid prototyping is based on the layered construction of a three-dimensional component. Two-dimensional layers (xy plane) are laid on top of one another. Depending on the thickness of the layers, a greater or lesser gradation of the component results in the direction of construction (z direction).

Two different methods of inkjet printing are currently in use for the preparation of three-dimensional bodies. In the first method, a binding-agent solution is printed onto a powder-bed layer. This binder “glues” the powder particles and thus fixes them in position. By fresh application of a further powder layer and fresh printing of the binder into the powder layer, a three-dimensional body can thus be generated in layers. Once the printing process is completed, the shaped body is removed from the powder packed bed and the excess powder removed. The generated shaped body can be used immediately if it has been prepared e.g. from plastic. If the shaped body consists of ceramic particles and is to finally produce a dense ceramic component, a thermal process step must still take place, in which the shaped body is debindered and densely sintered. During the debindering the organic binding agents are pyrolized. The process parameters of the debindering and sintering in this case are based on the type and proportion of the binding agent and on the ceramic material. A final surface treatment, such as e.g. polishing or glazing, is often necessary.

U.S. Pat. No. 6,322,728, which is hereby incorporated by reference, describes the use of such a process for the preparation of dental restorations. A disadvantage of this process is that, because of the low packing density of the powder bed and the resultant high porosity of the 3D object after the binding agent has burned out, it is very difficult to obtain a dense sintered compact. According to this process, shaped body densities of less than 50% of the theoretical density can usually be achieved after the debindering and densities of less than 95% of the theoretical density after the dense sintering. The low densities of the shaped bodies result in only an inadequate final strength, with the result that the bodies are hardly usable as dental workpieces.

In the second method, inks filled with solid particles are used and three-dimensional bodies are printed directly from them. In this method, no powder packed bed is required. Here too, the three-dimensional body is constructed in layers, by in each case printing and curing a two-dimensional layer (xy plane). The curing can take place for example by polymerization, drying or solidification by cooling. Simultaneously, an easily removable support material can be printed which makes it possible to print overhanging areas. Repeated printing of layers of modelling and optionally support material on top of each other (z direction) produces a three-dimensional object. After separating the printed object from the support structure, for example by selective chemical dissolution of the support material, there is a 3D component.

DE 10 2006 015 014 A1 and corresponding US2010040767 (A1), which is hereby incorporated by reference, disclose a process for the preparation of ceramic shaped bodies by layered inkjet printing of a suspension which contains 50 to 80 wt.-% ceramic particles, an aqueous boehmite sol, a low-molecular alcohol, a drying inhibitor and an organic liquefier, followed by drying and hardening of the layered composite. Each individual layer is preferably dried before the next layer is applied, a final drying after construction of the complete three-dimensional body is likewise preferred. The process is to be suitable for the preparation of tooth implants, inlays, crowns and bridges. A disadvantage is the exceptionally long time required for this process, as each individual printed layer must be dried.

EP 2 233 449 A1 and corresponding U.S. Pat. No. 8,133,831 (B2), which is hereby incorporated by reference, describe the preparation of ceramic shaped parts by a hot melt inkjet process. In this case, wax-containing slips filled with ceramic particles are printed at a temperature in the range of from 60 to 140° C. Immediately after striking the construction platform, the slip solidifies due to a drop in temperature. In addition, each layer is cured by photopolymerization. The thus-obtained green body is further processed by debindering and sintering.

The described processes result in ceramic shaped bodies which are constructed homogeneously from a ceramic. In order to imitate the appearance of the natural tooth as realistically as possible, it is, however, necessary to combine different materials which differ from each other for example in colour and translucence.

EP 1 859 757 A2 and corresponding U.S. Pat. No. 7,981,531 (B2), U.S. Pat. No. 8,025,992 (B2) and U.S. Pat. No. 8,173,562 (B2), which are hereby incorporated by reference, disclose a process for the preparation of ceramic dental restorations in which differently coloured ceramic powders are successively poured homogeneously in layers into a press mould depending on the desired layer thickness and colour progression. The powder is then cold isostatically pressed and then sintered to a blank. The blank is then shaped to a dental shaped part by milling or grinding by means of a CAD/CAM unit. In this process, the number of layers is limited for practical reasons and a colour progression can be achieved only in one spatial direction.

By gradient materials are meant materials of which the composition, structure and texture change gradually over the volume, which involves corresponding changes in the material properties. This creates the possibility of preparing materials which are adapted to particular uses. Gradient materials are also called graded materials or FGMs (functionally graded materials).

Graded materials are of great interest in many fields because of their particular physical properties. In technical fields, a targeted material design can be realized with the help of functionally graded shaped bodies in order to satisfy specific requirements in the respective field of use. Many efforts have been made to prepare graded materials. A functional grading results from the targeted construction of a workpiece by two or more materials. The most widely used material pairings in this case are ceramic-metal, ceramic-ceramic and ceramic-glass.

López-Esteban et al., Journal of the European Ceramic Society 22 (2002) 2799-2804, which is hereby incorporated by reference, disclose a functionally graded material which is obtained by dispersing ZrO₂ particles and steel powder in water. The solids content lies between 70 and 80 wt.-%. These dispersions are poured into plastic tubes, dried and then sintered. A gradient results from the different sedimentation rates of the particles.

Watanabe et al., Composites Part A 29A (1998) 595-601, which is hereby incorporated by reference, investigate the preparation of gradient materials by the centrifugation of mixtures of gypsum and corundum particles. The materials serve as modelling materials for testing computer simulations.

Balla et al., Acta Biomaterials 5 (2009) 1831-1837, which is hereby incorporated by reference, disclose the preparation of Ti—TiO₂ gradient materials by layered laser irradiation of Ti and TiO₂ powders (laser engineered net shaping), wherein the TiO₂ content is increased from layer to layer. The presence of TiO₂ on titanium surfaces is to improve their wettability and thus reduce the coefficient of friction to ultra-high-molecular-weight polyethylene. The materials are to be advantageous for the preparation of artificial hip joints.

Takagi et al., Journal of the European Ceramic Society 23 (2003) 1577-1583, which is hereby incorporated by reference, disclose the preparation of lead zirconate titanate (PZT)/Pt piezoelectric composites and adjustment units made of gradient material. Both the composites and the adjustment units are prepared from PZT and platinum powder by isostatic pressing and sintering. The adjustment units consist of seven layers with a centre-symmetrical profile. The platinum content decreases progressively from the central layer to the surface layer from 30% platinum to 0% platinum.

Moon et al., Materials Science and Engineering A298 (2001) 110-119, which is hereby incorporated by reference, describe the preparation of SiC—Si gradient materials by a three-dimensional printing process. For this, porous bodies, the porosity of which is varied by the printing process, are first prepared from carbon powder by three-dimensional printing. The porous carbon shaped bodies are then immersed in vacuum in an Si melt and infiltrated with the molten silicon. During the three-dimensional printing, a binding agent is introduced selectively into a powder bed by inkjet printing. A new powder layer is applied to the thus-formed layer and this is then selectively cured again by introducing binding agent. This sequence of process steps is repeated until the desired body is completed.

C. Kaya, Journal of the European Ceramic Society 23 (2003) 1655-1660, which is hereby incorporated by reference, discloses the preparation of Al₂O₃—ZrO₂/Al₂O₃ gradient materials by electrophoretic deposition. In this case, a rod-shaped steel electrode is first immersed in a suspension of zirconium dioxide and boehmite. The boehmite and zirconium dioxide particles are deposited on the electrode by applying a voltage. The electrode is then transferred into an Al₂O₃ dispersion and an aluminium oxide layer is deposited on the boehmite and zirconium dioxide layer. The thus-obtained tubular body was then dried and sintered.

Hvizdo\check{s} et al., Journal of the European Ceramic Society 27 (2007) 1365-1371, which is hereby incorporated by reference, describe the preparation by electrophoretic deposition of gradient materials constructed in layers. The materials have an inner layer of 70% Al₂O₃ and 30% ZrO₂ as well as two outer layers each of 90% Al₂O₃ and 10% ZrO₂.

Merino et al., Journal of the European Ceramic Society 30 (2010) 147-152, which is hereby incorporated by reference, disclose the preparation of ZrO₂/NiO gradient materials by surface melting of sintered, eutectic NiO/ZrO₂ ceramics with a laser.

Yoo et al., J. Am. Ceram. SOC., 81 (1) 21-32 (1998), which is hereby incorporated by reference, describe the preparation of multi-layered ceramic gradient materials based on zirconia toughened alumina (ZTA) by a three-dimensional printing process. In this case, an aqueous yttrium nitrate solution is printed into a powder bed of Al₂O₃ and ZrO₂ particles. During the subsequent sintering and cooling, the Y₂O₃ formed controls the transformation from tetragonal to monoclinic ZrO₂ phases in the ZTA and thus the strength of the material. The doping with different quantities of Y₂O₃ during the printing leads to the formation of different proportions of tetragonal and monoclinic phases. Shaped bodies with up to five layers were able to be prepared which, however, still had to be isostatically pressed after the printing process in order to achieve the necessary green density. Thermomechanical stresses led, during the cooling, to cracking at the boundary surface between monoclinic and tetragonal phases.

Cannillo et al., Journal of the European Ceramic Society 27 (2007) 1293-1298, which is hereby incorporated by reference, compare different processes for the preparation of gradient materials based on glass ceramic. In the so-called percolation method, a glass is applied to sintered aluminium oxide and then melted, with the result that it can penetrate the aluminium oxide. In the second method, layers of glass and aluminium oxide are deposited on an aluminium substrate using a plasma torch. This process has proved more controllable and reproducible than the percolation process.

Mott and Evans, Materials Science and Engineering A271 (1999) 344-352, which is hereby incorporated by reference, describe the preparation of zirconium dioxide/aluminium oxide gradient materials by direct inkjet printing of ceramic inks. The grading is produced by first filling the ink reservoir of the printhead with zirconium oxide ink and then replacing the ink used during the printing with aluminium oxide ink, with the result that the proportion of aluminium oxide in the ink increases over the course of the printing procedure. The solids content in the inks used is in this case 2.5 vol.-%. This procedure is controllable only to a limited extent. Small plates with 1,200 layers are prepared which are dried for 120 h at room temperature after the printing and then sintered. The shaped bodies obtained had significant porosities.

The preparation of graded shaped bodies is a very costly process in technical terms. None of the described processes is satisfactory in every respect. In practice, graded workpieces are currently prepared mainly via the dry-pressing process. In the dry-pressing technique, the female mould must be progressively filled with the different materials, and the blank is axially compressed and optionally then cold isostatically pressed. Dry-pressed graded shaped bodies have only a two-dimensional grading, a three-dimensional grading cannot be implemented practically with this process. The components are constructed from several layers of different materials and thus have a layered grading. Each individual layer consists either of the same material in each case or of a mixture of different materials that is defined for the respective layer. Other manufacturing processes, such as e.g. electrophoresis, infiltration techniques, plasma spray processes or surface laser treatments, are still in the trial phase and only now the subject of current studies. The emphasis is mainly on the evaluation of the possibilities and limits of the chosen processes as well as the characterization of the specific properties of the thus-generated shaped bodies. These processes are, [according to] the current state of the art, suitable only for the construction of gradient materials the gradation of which changes in a spatial direction.

### SUMMARY

The object of the invention is to overcome the disadvantages of the known state of the art and to provide a process for the preparation of a ceramic shaped body which is suitable in particular for the preparation of dental restorations. The process is to make possible the targeted, independent variation of material properties such as e.g. colour, translucence and/or mechanical strength in all three spatial directions and to produce densely sintered shaped bodies with high final density. In particular, the object of the invention is to provide a process which allows the preparation of dental restorations with high mechanical load capacity and good visual properties, i.e. as natural as possible an appearance.

### BRIEF DESCRIPTION OF THE DRAWINGS

Embodiments of the present invention will be more fully understood and appreciated by the following Detailed Description in conjunction with the accompanying drawings, in which:

FIG. 1 schematically shows the formation of a layer 1 of a shaped body on a construction platform (support) 2 with an inkjet printhead 3. The printhead has two printhead sets 4 and 5. A reservoir 6 or 7 which is filled with slip A or slip B respectively is allocated to each of the printhead sets.

FIG. 2 schematically shows the layer generated in FIG. 1 in top view.

FIG. 3 schematically shows a printed, cubic shaped body the composition of which passes continuously from the spherical core made of material B (100% material B) into material A (100% material A) towards the edge.

FIG. 4 shows a schematic representation of a bridge frame strengthened at 8 and 9 (connections) for a dental bridge.

### DETAILED DESCRIPTION

Embodiments of the invention are achieved by an inkjet printing process for the generative preparation of shaped bodies, in which

(a) ceramic slips are applied in layers to a support and cured,

(b) a further layer is applied to the cured layer and cured,

(c) step (b) is repeated until a body with the desired geometric shape is obtained,

(d) the body is then subjected to a chemical treatment or a heat treatment to remove the binding agent (debindering), and

(e) the body from step (d) is sintered.

The process is characterized in that at least two differently composed ceramic slips are used to prepare the shaped bodies. The ceramic slips are applied such that the relative proportions of the slips are controlled dependent on position, with the result that the applied relative proportions of the slips within a layer vary along at least one direction in the layer plane in a predeterminable manner, wherein the application pattern for the slips can vary from layer to layer. As a result of the variation in the composition, shaped bodies can be prepared the material properties of which vary in three spatial directions (x,y,z). Such shaped bodies are also called graded shaped bodies in the following. In addition to layers with varying composition, the shaped bodies can also contain layers with homogeneous composition, i.e., layers which contain only one ceramic slip or a homogeneous mixture of different slips.

The formulation that the relative proportions of the slips within a layer vary along at least one direction in the layer plane in a predeterminable manner also comprises embodiments in which, in addition to areas varying in the at least one direction, this layer also contains areas of constant composition.

The shaped bodies prepared by the process according to the invention are also a subject of the invention.

The ceramic slips are preferably applied in layers by an inkjet printing process, e.g., with the help of a so-called inkjet printer. Systems consisting of an inkjet printer which is suitable for printing ceramic slips and at least two different ceramic slips are likewise a subject of the invention.

The slips used according to the invention are suspensions of ceramic particles in a dispersing agent. The slips are also called ceramic-filled inkjet inks, or simply inks, here.

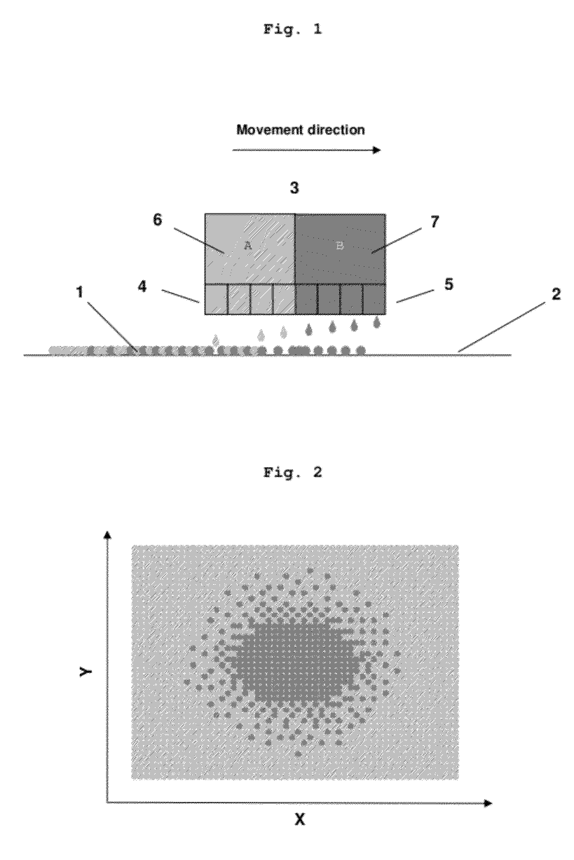

In the 3D inkjet printing process, a targeted dosing and positioning of individual drops of ceramic-filled inks takes place. In the process according to the invention, so-called multi-nozzles are preferably used, e.g. piezo DoD (drop on demand) multi-nozzle high-temperature printheads the nozzles of which can be controlled individually (FIG. 1). Such printheads are described e.g. in Menzel et al., MEMS Solutions for Precision Micro-Fluidic Dispensing Application, NIP20: International Conference on Digital Printing Technologies, Salt Lake City, Utah, October 2004, Volume 20, pages 169-175, which is hereby incorporated by reference. The shape and number of drops are controllable here by different control parameters, such as temperature, stress, pulse progression and frequency. The frequency of the generation of drops is directly linked to the feed rate of the printhead(s), with the result that a closed layer construction is achieved by placing many individual drops alongside one another (FIG. 2). The drop volume is for example 90 pl with a nozzle diameter of 50 μm and a 36 vol.-% wax-based ZrO₂ ink. From this, the height that forms of the printed and solidified drop and thus ultimately the layer thickness of the individual layer are due to the drop volume and its specific properties, such as e.g., surface tension, wetting behaviour, viscosity and polymerization behaviour. The layer thickness of the individual layer can be varied by overlaying printing of the individual drops and is approximately 15-30 μm in the above example. The efficiency of the printing process can additionally be increased through the use of several multi-nozzle (high-temperature) printheads which are jointly fed from a reservoir. The resolution with this process is e.g., 500 dpi, the positional accuracy ±50 μm, with a repeat accuracy of ±30 μm.

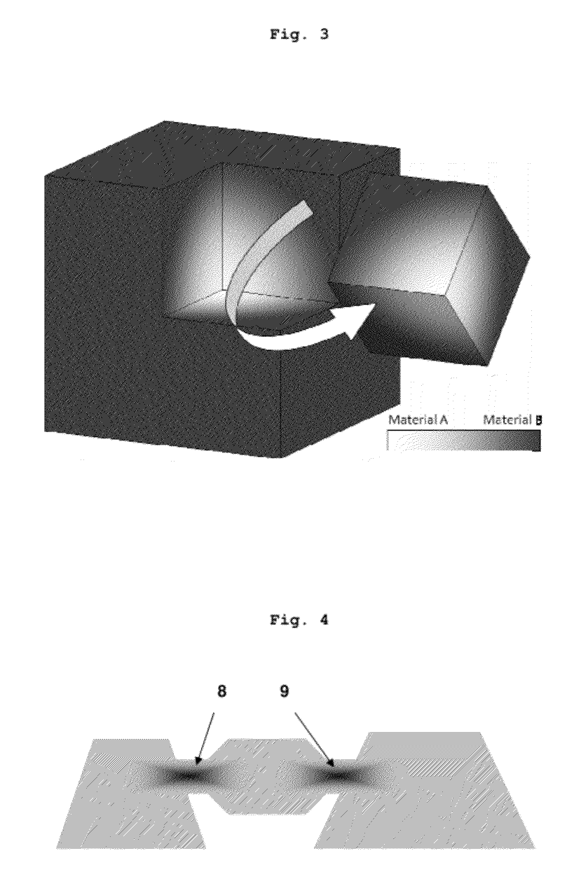

A three-dimensional shaped body is generated during the printing process by a layered construction through a controlled shift in the position of the printhead(s) relative to the construction platform (support) in the spatial directions x and y and, after completion of the respective x-y plane, in z direction. If e.g., the chemical composition of the individual layers printed on top of each other is varied, a spatial gradient is produced in the chemical composition. This is schematically represented in FIG. 3. FIG. 3 shows a cubic shaped body with a spherical core of material A which passes discretely into material B towards the edge of the cube. Both the geometry and the spatial extent of the core material can be defined in advance.

According to the invention, a printer with several printheads is preferably used. The printer preferably has at least two printheads which are each supplied from different reservoirs, with the result that two or more different slips can be printed. These printheads preferably each have several nozzles, i.e., they are so-called multi-nozzle printheads. Particularly preferably, the printer has 3 to 20 and quite particularly preferably 6 to 10 printheads which are charged individually or in groups from different reservoirs (e.g., two printheads are charged from reservoir A, two further printheads are charged from reservoir B).

To prepare graded bodies, a support material is preferably printed from a separate printhead in steps (a) and (b) together with the ceramic slip or following these steps. Support materials here are materials which serve in particular to support undercuts and overhangs of the printed bodies. In particular the binding agents and waxes used to prepare the slips are suitable as support materials. The support materials do not contain ceramic fillers, but can contain non-strengthening inorganic fillers, such as e.g. chalk, talc, which make the mechanical removal of the support structure easier.

The printing of the support material preferably takes place with one or two further printheads which are fed e.g., from Reservoir C. Reservoirs A and B respectively contain ceramic slips which differ in their composition (e.g., reservoir A filled with ink A, reservoir B contains ink B). A two-dimensional layer is printed through a targeted actuation of the printheads of the respective reservoirs A and B (see FIG. 1), the chemical composition of which varies over the extent of the layer (see FIG. 2). Areas which correspond to voids in the sintered shaped bodies are printed with the support material. Here too, multi-nozzle printheads are preferred.

The unsintered body obtained by layered construction is called a green body or green compact. According to the invention, a green compact is prepared by shaping two or more slips, e.g., in an inkjet printing process, to the desired geometric shape. The green compact is here constructed through the generation of individual drops. An advantage of the process according to the invention is that the composition of the shaped bodies can be set spot-accurately by variation of the slips used.

The curing of the generated drops of particle-filled inks or of support material preferably takes place by temperature change and in particular by radical polymerization, particularly preferably by photopolymerization. The curing can take place in layers. According to a particularly preferred embodiment of the process according to the invention, however, each generated drop is cured directly after it strikes the construction platform or the preceding layer and its position and extent is thus fixed. Wax-containing slips are cured by cooling and polymerization, wax-free slips by polymerization exclusively. The generated drops or layers are preferably illuminated parallel to the printing process, e.g., by light sources arranged to the side of the printheads, for example by UV or blue light lamps. The illumination preferably takes place with light in the wavelength range of 200-550 nm, preferably with a luminous power of at least 500 mW/cm².

The wax-free slips used in steps (a) and (b) preferably have the following respective compositions

(A) 25 to 55 vol.-%, preferably 30 to 45 vol.-%, particularly preferably 30 to 38 vol.-% ceramic particles, and

(B) 45 to 75 vol.-%, preferably 55 to 70 vol.-%, particularly preferably 62 to 70 vol.-% radically polymerizable binding agent.

The wax-containing slips used in steps (a) and (b) preferably have the following respective compositions

(A) 25 to 55 vol.-%, preferably 30 to 45 vol.-%, particularly preferably 30 to 38 vol.-% ceramic particles,

(B) 6 to 50 vol.-%, preferably 8 to 30 vol.-%, particularly preferably 10 to 30 vol.-% radically polymerizable binding agent and

(C) 25 to 69 vol.-%, preferably 30 to 60 vol.-%, particularly preferably 35 to 45 vol.-% wax.

Slips with a content of ceramic particles (A) of more than 30 vol.-% are particularly preferred according to the invention.

According to the invention, at least two differently composed slips are used. By differently composed slips are meant slips the different composition of which can be demonstrated in the shaped body after the debindering and sintering. Two slips which differ for example exclusively in the composition of the binding agent (B) removable during the debindering are not differently composed slips within the meaning of the invention.

According to the invention, the use of two or more slips which differ in the composition of the ceramic particles is preferred. This is to be understood as meaning that the ceramic particles consist of different ceramics (slip A contains particles of ceramic A; slip B particles of ceramic B, etc.) and/or contain differently composed mixtures of ceramic particles (slip A contains e.g., 30% particles of ceramic A and 70% particles of ceramic B; slip B contains 70% particles of ceramic A and 30% particles of ceramic B; or slip A contains particles of ceramic A and slip B a mixture of particles of ceramic A and particles of ceramic B; etc.). The ceramics can differ in their chemical composition, their colour, their translucence, their mechanical properties alone or in several parameters at the same time. There is also a different composition of ceramic particles when these are differently coloured. Preferably, the different colourings of the ceramic particles of the slips used are achieved by coating the particles with chromophoric components, as is described further below.

A different composition of the slips used according to the invention with an otherwise identical composition can also be achieved by adding different chromophoric components to the slips. For this, substances are suitable in particular which lead to a colouring of the prepared shaped body, preferably to a tooth-colour colouring, during debindering or sintering. Preferred chromophoric components are described in paragraph [0062] of EP 2 151 214 A1 and corresponding U.S. Pat. No. 7,927,538 (B2), which is hereby incorporated by reference, and in paragraph [0043] of EP 2 233 449 A1 and U.S. Pat. No. 8,133,831 (B2), which is hereby incorporated by reference.

Transition metal compounds preferred as chromophoric component are include, but are not limited to, acetylacetonates or carboxylic acid salts of the elements iron, cerium, praseodymium, terbium, lanthanum, tungsten, osmium, terbium and manganese. The salts of the carboxylic acids, acetic, propionic, butyric, 2-ethylhexyl carboxylic, stearic and palmitic acid are preferred. Particularly preferred are the corresponding Fe, Pr, Mn and Tb compounds, such as e.g. iron (III) acetate or acetylacetonate, manganese (III) acetate or acetylacetonate, praseodymium (III) acetate or acetylacetonate or terbium (III) acetate or acetylacetonate as well as the corresponding carboxylic acid salts. The chromophoric component is preferably used in a quantity of from 0.00001 to 2.0 wt.-%, particularly preferably 0.001 to 1.0 wt.-% and quite particularly preferably 0.01 to 0.5 wt.-%, relative to the total mass of the ceramic particles (A).

In the case of oxide ceramic particles, the chromophoric components are preferably applied to the ceramic particles. The process according to EP 1 859 757 A2 and corresponding U.S. Pat. No. 7,981,531 (B2), U.S. Pat. No. 8,025,992 (B2) and U.S. Pat. No. 8,173,562 (B2), is particularly preferred. In this process, the chromophoric substance is applied to an uncoloured oxide ceramic powder in a fluid-bed reactor. Aqueous solutions of the above-described salts can preferably be used as chromophoric substances. Water-soluble salts of d-block or f-block elements of the periodic table are preferred. Nitrate or chloride hydrates are particularly preferred. Examples of usable salts include Pr(NO₃)₃.5H₂O, Fe(NO₃)₃.9H₂O or Tb(NO₃)₃.5H₂O. The oxide ceramic powders encased in the chromophoric substances are then preferably screened, e.g. sieved with sieves of a mesh size of <90 μm. This is carried out in particular when there is too great an agglomeration of the powder.

The particles coloured in the fluidized bed can be calcined in advance before they are worked up into an ink. The calcining of the particles takes place at temperatures of from 100 to 600° C., preferably at 200 to 550° C., particularly preferably at 300 to 500° C. for a period of from 1 to 10 h, preferably for 2 to 6 h, particularly preferably for 2 to 4 h.

It is also possible to print the components used to colour the ceramic particles from one or more separate printheads in the form of separate inks.

Particles of glasses and glass ceramics can be coloured according to the state of the art with oxides of the transition elements.

Component (A) of the slip used according to the invention is ceramic particles, wherein by “ceramic particles” are meant oxide ceramic particles and glass ceramic particles but also glass particles, preferably oxide ceramic or glass ceramic particles and mixtures of glass ceramic and glass particles. Oxide ceramics are solid, polycrystalline, silicic acid-free materials of oxides or oxide compounds, preferably of metal oxide powders such as ZrO₂ and/or Al₂O₃, which can be sintered without decomposition. Glass ceramics are polycrystalline solids which, in addition to one or more crystalline phases, additionally also contain glass phase proportions. Glass ceramics are formed from glasses by controlled crystallization. Glass ceramics containing leucite, apatite or lithium disilicate are preferred. Particles of glasses which can be converted into glass ceramics by crystallization are preferred as glass powder. For this, the glasses must necessarily contain necessary crystallization nuclei. The crystallization can be initiated by the debindering, sintering or a separate temperature treatment.

The oxide ceramic particles used as component (A) are preferably oxide ceramic particles based on ZrO₂ and/or Al₂O₃, for example oxide particles of ZrO₂, Al₂O₃ or ZrO₂—Al₂O₃, or oxide particles of ZrO₂ or ZrO₂—Al₂O₃, stabilized with Y₂O₃ or MgO.

Stabilized oxide ceramics which, in addition to the base oxide ZrO₂, contain a stabilizing agent are particularly preferred. Y₂O₃, CeO₂ or mixtures of the two stabilizing agents are preferably used as a stabilizing agent. Y₂O₃ is customarily used here in the concentration of up to 5 mol.-%. Dopings of up to 12 mol.-%, relative to the mass of the stabilized ceramic, are usual for CeO₂. These ZrO₂ ceramics are called Y-TZP (yttrium-stabilized tetragonal zirconium dioxide polycrystals) or Ce-TZP (cerium-stabilized tetragonal zirconium dioxide polycrystals) respectively. The strength of Y-TZP can be further increased by adding Al₂O₃. Such ceramics are called AZT (alumina toughened zirconia). A preferred AZT contains 80 wt.-% Y-TZP and 20 wt.-% Al₂O₃ and has a mechanical bending strength of 2,000 MPa.

Oxide ceramics which consist exclusively of the named substances are preferred.

In the preparation of dental restorations, on the one hand, a high mechanical load capacity is sought, for example in the preparation of bridges, but on the other hand dental restorations are to have as natural as possible an appearance. Neither property can normally be best realized with a single material. However, neither is any combination of different materials for optimizing these properties possible, as e.g., different thermal expansion coefficients can lead to thermo-mechanical stresses, and different sintering temperatures to an undesirably high porosity.

According to the invention, it has now been found that a high mechanical strength and good visual properties can be achieved without the named disadvantages by using at least one first slip based on ZrO₂ and in particular based on Y-TZP (basic slip) and at least one second slip based on Al₂O₃ (secondary slip) as slips in the process steps (a) to (c).

The basic slip preferably contains exclusively Y-TZP particles as ceramic particles. In this process, several differently coloured basic slips can also be used, wherein the use of slips which contain different coloured Y-TZP particles is preferred.

The secondary slip preferably contains particles of a ceramic which contains 20 to 100 wt.-% Al₂O₃ and 0 to 80 wt.-% Y-TZP, preferably 40 to 60 wt.-% Al₂O₃ and 60 to 40 wt.-% Y-TZP, particularly preferably 20 wt.-% Al₂O₃ and 80 wt.-% Y-TZP. Slips which contain exclusively particles of Al₂O₃ or Al₂O₃ and Y-TZP are preferred. Several differently coloured secondary slips can be used, wherein here too the use of slips which contain different coloured Al₂O₃ and/or Y-TZP particles is preferred.

A local strengthening of ceramic shaped bodies is of great importance for example in the preparation of full ceramic bridge frames. A targeted strengthening of a ceramic bridge frame, e.g. of Y-TZP, in the mechanically particularly stressed connection element area, as represented schematically in FIG. 4, is advantageously possible through the use e.g. of ATZ, as the thermal expansion coefficients of the two ceramics (Y-TZP and ATZ ceramic) do not differ significantly from each other. In aesthetically important areas (caps and bridge elements), in contrast, the more translucent Y-TZP is used.

ATZ (alumina toughened zirconia) ceramic with 80 wt.-% Y-TZP and 20 wt.-% Al₂O₃ is particularly suitable, because of its mechanical properties, for targeted strengthening of mechanically stressed areas of dental restorations. According to the invention, this can be achieved by printing basic slips and secondary slips such that a ratio of 20 wt.-% Al₂O₃ to 80 wt.-% Y-TZP is achieved in the areas to be strengthened. The mixture ratio can be adjusted during the printing procedure. It can be achieved through the use of slips which contain 100 wt.-% Y-TZP or 100 wt.-% Al₂O₃, in each case relative to the proportion of ceramic in the slip, or also by slips which contain e.g. 100 wt.-% Y-TZP or 20 wt.-% Al₂O₃ and 80 wt.-% Y-TZP, wherein in the second case the areas to be strengthened are formed by printing only the secondary slip. This variant is preferred according to the invention. The transition from the strengthened connection area (ATZ ceramic) to the more translucent cap is preferably gradual, in order to achieve a smooth transition between the two materials and thus to achieve a homogeneous ceramic structure.

Colour gradations targeted by the process according to the invention can also be realized in the preparation of oxide ceramic dental prostheses. For this, several differently coloured slips are used in the above-described process. Preferably 2 or more, particularly preferably 2 to 10 and quite particularly preferably 3 to 6, differently coloured slips are used for the colour gradation. As natural teeth differ not only with regard to colour, colour intensity and brightness, but also in translucence, it is advantageous for the preparation of natural-looking, tooth-colour, full ceramic dental restorations to use more than two slips for the construction of the gradient, wherein the number thereof ultimately depends on the tooth colour and on the aesthetic demands made of the dental restoration. Inks based on coloured ZrO₂ or Y-TZP particles are preferably used for the construction of colour-graded dental restorations with high mechanical load capacity.

Dental restorations with particularly natural colour progressions can be prepared if glass ceramic particles or a mixture of glass and glass ceramic particles are used as component (A). Leucite, apatite and/or lithium disilicate glass ceramic particles are particularly preferred. The colour gradation preferably takes place by printing 2 or more, particularly preferably 2 to 10 and quite particularly preferably 3 to 6 inks with differently coloured particles. Here, the areas of the restorations in marginal and central areas are constructed from more intensely coloured and clouded particles, while in the incisal and peripheral areas less strongly coloured and less clouded particles are used, similar to the natural tooth colour progression.

The ceramic particles should be clearly smaller than the average diameter of the nozzle of the printhead of the inkjet printer with which the slip is printed. In order to make it possible to print with common inkjet printers which have e.g., a nozzle diameter of approximately 100 μm or smaller, in the slips according to the invention so-called submicron powders are preferably used, i.e., ceramic particles with a maximum particle size of less than or equal to 5 μm, in particular less than or equal to 1 μm. The particles preferably have a size of from 0.01 to 5 μm, particularly preferably from 0.1 to 1 μm and quite particularly preferably from 0.3 to 0.6 μm.

By “particle size” is meant the actual size of the ceramic particles as present in the slip. Typically, this is the primary particle size, as agglomerates possibly present in the ceramic powder are largely broken down into primary particles during the preparation of the slip. However, there may also be agglomerates of ceramic primary particles in the slip if they are small enough to be printable with the desired inkjet nozzle, i.e., in preferred embodiments the agglomerates as a whole meet the above particle size conditions.

In the case of Al₂O₃ the size of the primary particles used as component (A) preferably lies in the range of from 50 to 500 nm, particularly preferably between 75 and 200 nm; in the case of Y-TZP in the range of from 50 to 500 nm, quite preferably between 50 and 350 nm. The glass/glass ceramic particles used have a primary particle size of from 0.1 to 10 μm, particularly preferably from 0.5 to 5 μm. The primary particle sizes are the absolute upper and lower limits.

The ceramic particles are preferably approximately spherical. It is furthermore beneficial if the particles are present in non-agglomerated form, for example entirely or predominantly in the form of primary particles.

Radically polymerizable monomers or mixtures thereof are preferred as radically polymerizable binding agents (component B) of the slip used according to the invention. The monomer is preferably liquid at 20° C. The melting point is preferably below 0° C. The monomer is preferably homogeneously, i.e., without phase separation, miscible with the optional wax (C). The monomer should not decompose at processing temperature, roughly the temperature described later in the case of inkjet printing. The monomer typically has a large non-polar residue, e.g. a C₈ to C₂₀ residue.

In particular, monomers which have one or more, e.g. two, (meth)acryloyl groups are used in the slips, wherein monomers with (meth)acryloyloxy groups are preferred. Examples of suitable radically polymerizable monomers are (meth)acrylates and di(meth)acrylates with a chain length of the alcohol residue of from C₈ to C₁₈, such as for instance octadecyl acrylate; multi-(meth)acrylated glycols, in particular multi-(meth)acrylated propylene glycols; multi-(meth)acrylated short- to medium-chain polypropylene glycols with a preferred M_{w} of 200-2000, particularly preferably 300-1000, such as for instance dipropylene glycol diacrylate and polypropylene glycol diacrylates, e.g. polypropylene glycol 400 diacrylate; pentaerythritol di(meth)acrylate monocarboxylates with a chain length of from C₈ to C₁₈, such as for instance pentaerythritol diacrylate monostearate, and mixtures thereof. The acrylated monomers are preferred to the methacrylated monomers, in particular the previously named acrylated monomers are preferred. In an embodiment of the present invention, component (B) is a mixture of octadecyl acrylate and pentaerythritol diacrylate monostearate.

The optional component (C) of the slips used according to the invention is a wax. In the present invention, the term “wax” is to be understood as defined by the Deutsche Gesellschaft für Fettwissenschaft in the DGF standard method M-I 1 (75). As the chemical composition and origin of different waxes differ greatly, waxes are defined only via their mechanical-physical properties. A substance is called wax if it can be kneaded at 20° C., is strong to brittle hard, has a coarse to finely crystalline structure and is translucent to opaque in colour, but not glass-like; it melts above 40° C. without decomposing, is readily liquid (of low viscosity) a little above the melting point and not stringy; it has a strongly temperature-dependent consistency and solubility, and can be polished under light pressure. Waxes typically pass into the molten state between 40 and 130° C.; waxes are normally insoluble in water. Waxes for use in the slip according to the invention preferably have a melting point in the range of from 40 to less than 80° C., particularly preferably from 45 to 65° C. and quite particularly preferably from 54 to 56° C. At 80° C. and a shear rate of 1000 s⁻¹, preferred waxes have a viscosity of ≦10 mPa·s, in particular from 5 to 10 mPa·s and particularly preferably from 3 to 4 mPa·s.

Depending on their origin, waxes are divided into three main groups: natural waxes, wherein here again a distinction is drawn between vegetable and animal waxes, mineral waxes and petrochemical waxes; chemically modified waxes and synthetic waxes. The wax used as component (C) in the slip according to the invention can consist of one wax type or also of mixtures of different wax types. In the present invention, preferably petrochemical waxes, such as for instance paraffin wax (hard paraffin), petroleum jelly, microcrystalline wax (micro paraffin) and mixtures thereof, particularly preferably paraffin wax, are used. Paraffin waxes that are commercially available as injection moulding binders for the manufacture of oxide ceramic and non-oxide ceramic components in the hot-moulding process (low-pressure injection moulding) are very suitable, e.g. paraffin wax with a melting point of approximately 54-56° C., a viscosity of 3-4 mPa·s at 80° C. and a shear rate of 1000 s⁻¹, which can be obtained from inter alia Zschimmer & Schwarz (Lahnstein, DE) under the name SILIPLAST. Commercially available waxes often already contain emulsifiers and/or further components to adjust the rheology.

As wax component (C), it is also possible to use vegetable waxes, e.g. candelilla wax, carnauba wax, Japan wax, esparto wax, cork wax, guaruma wax, rice germ oil wax, sugar cane wax, ouricury wax, montan wax; animal waxes, e.g. beeswax, shellac wax, spermaceti, lanolin (wool wax), rump fat; mineral waxes, e.g. ceresin, ozokerite (earth wax); chemically modified waxes, e.g. montan ester waxes, sasol waxes, hydrogenated jojoba waxes, or synthetic waxes, e.g. polyalkylene waxes, polyethylene glycol waxes.

Emulsifiers (component (D)) can be used in addition to or preferably as an alternative to component (C), in a particularly preferred composition glycerides of fatty acids and in particular polypropylene glycols are used. The polypropylene glycols here preferably have a chain length of from 100 to 1000, particularly preferably 100 to 600, quite particularly preferably 200 to 400. The emulsifier D is preferably used in a quantity of from 0.5 to 10 vol.-%, quite particularly preferably 1 to 5 vol.-%, in each case relative to the total mass of the slip.

The slips preferably contain a polymerization initiator as component (E).

Suitable polymerization initiators are radical polymerization initiators, in particular photoinitiators. The known radical photoinitiators for the visible range (cf. J. P. Fouassier, J. F. Rabek (ed.), Radiation Curing in Polymer Science and Technology, Vol. II, Elsevier Applied Science, London and New York 1993) can be used, such as e.g. acyl or bisacylphosphine oxides, preferably a-diketones such as 9,10-phenanthrenequinone, diacetyl, furil, anisil, 4,4′-dichlorobenzil and 4,4′-dialkoxybenzil and camphorquinone. To accelerate the initiation, α-diketones are used, preferably in combination with aromatic amines. Redox systems which have proved particularly worthwhile are combinations of camphorquinone with amines, such as N,N-dimethyl-p-toluidine, N,N-dihydroxyethyl-p-toluidine, 4-dimethylaminobenzoic acid ethyl ester or structurally related systems.

Norrish type I photoinitiators, above all monoacyltrialkyl- or diacyldialkylgermanium compounds, such as e.g. benzoyltrimethylgermanium, dibenzoyldiethylgermanium or bis(4-methoxybenzoyl)diethylgermanium, are particularly preferred photoinitiators. Mixtures of the different photoinitiators can also be used, such as e.g. dibenzoyldiethylgermanium combined with camphorquinone and 4-dimethylaminobenzoic acid ethyl ester.

The polymerization initiator (E) is used in a quantity of from 0.001 to 3.0 vol.-%, preferably from 0.01 to 1 vol.-%, quite particularly preferably from 0.05 to 0.8 vol.-%, in each case relative to the total mass of the slip.

In addition to the previously named components, the slips can optionally contain further additives (F), such as for instance stabilizers (inhibitors), dispersion auxiliaries, melt viscosity-lowering substances (component for adjusting the rheology) and combinations thereof. These are added to the slips in a quantity of from 0.01 to 5 vol.-%.

The stabilizers (inhibitors) improve the storage stability of the slips and in addition prevent an uncontrolled polyreaction. The inhibitors are preferably added in such a quantity that the slips are storage stable over a period of from approximately 2 to 3 years. Examples of suitable inhibitors comprise the 2,2,6,6-tetramethylpiperidin-1-oxyl radical (TEMPO), phenothiazine, iodine and copper(I) iodide. The inhibitors are preferably used in a quantity of from 5 to 500 wt.-ppm, particularly preferably 50 to 200 wt.-ppm, in each case relative to the total mass of the monomer(s). Relative to the total composition of the slip, the inhibitors are preferably used in a quantity of from 0.03 to 3 vol.-%, preferably 0.3 to 1.2 vol.-%.

All usual dispersion auxiliaries for dispersing oxidic particles in a non-polar medium can be used as dispersion auxiliary. Suitable dispersion auxiliaries typically have a polar “anchor group” which can be bonded to the particle surface and a non-polar group pointing away from the particle which brings about a maximum steric stabilization of the suspension. Preferred dispersion auxiliaries are polyester-based dispersion auxiliaries, such as e.g., Hypermer LP-1 from Uniqema, GB. The dispersion auxiliary is preferably used in a quantity of from 0.1 to 5 wt.-%, preferably 0.5 to 2 wt.-% and in particular 1.1 to 1.5 wt.-%, in each case relative to the total mass of ceramic particles. Relative to the total composition of the slip, dispersion auxiliaries are preferably used in a quantity of from 0.3 to 16 vol.-%, preferably 1.6 to 6.4 vol.-% and in particular 2.0 to 4.8 vol.-%.

The total quantity of component(s) (F) is preferably 0.1 to 15 vol.-%, particularly preferably 0.1 to 10 vol.-%, quite particularly preferably 0.5 to 9 wt.-% and in particular 1.5 to 5 vol.-% relative to the overall composition of the slip.

A melt viscosity-lowering substance can be added to the slip according to the invention, in order to reduce its viscosity in the liquid state. Longer chain (C₈-C₂₀) olefins that are solid at room temperature and have a low melting point, such as for instance hexadecene and octadecene, for example are suitable for this.

Wax-containing slips usually have a pasty to solid consistency at 20° C. Thus a sedimentation of the ceramic particles is avoided and a high storage stability is guaranteed. At 80° C. and with a shear rate of 1000 s⁻¹, it preferably has a viscosity of ≦200 mPa·s, particularly preferably ≦100 mPa·s. The slip according to the invention can preferably be printed at a corresponding temperature with an inkjet printer which has a printhead nozzle with a diameter of approximately 100 μm.

The slips can be prepared by dispersing the ceramic particles in the binding agent, e.g., a mixture of wax, monomers and optional additives. The dispersion preferably takes place at a temperature at which the wax and preferably also the monomers are liquid, preferably at 70 to 110° C. According to a further preferred embodiment, the dispersion takes place applying high shear rates, for example at 500 to 5,000 s⁻¹. The filler can be dispersed for example using a dissolver (e.g. Dispermat® from VMA-Getzmann GmbH, Reichshof, DE) at rotational speeds of up to 3,000/min, and preferably at increased temperature of from 70 to 110° C. in the mixture of wax, monomers and optional additives. Under these conditions, agglomerates of the preferred ceramic powders are largely broken down into the primary particles. If the viscosity in the liquid slips should be too high, it is reduced, by adding viscosity-lowering substances, to values of preferably ≦200 mPa·s, particularly preferably ≦100 mPa·s, measured at a shear rate of 1000 s⁻¹ and a temperature of 80° C.

The wax-free inks differ from the wax-containing ones in that they do not solidify by cooling to room temperature and are thus liquid at room temperature. The preparation can take place e.g., at temperatures of from 40 to 60° C. using a dissolver (e.g. Dispermat® from VMA-Getzmann GmbH, Reichshof, D) at rotational speeds of up to 3,000/min. The inks preferably have a viscosity of ≦5,000 mPas and in particular of ≦500 mPa·s at room temperature, if the temperature is increased to 40 to 90° C. this preferably reduces to ≦200 mPa·s, measured at a shear rate of 1000 s⁻¹.

According to a particularly preferred process for the preparation of the slips, the ceramic particles are first mixed in a Turbula mixer (e.g. type T2C from Willy. A. Bachhofen AG Maschinenfabrik, Muttenz, CH) and this mixture is then processed in the dissolver under the above-listed conditions, in order to achieve an effective deagglomeration of the particles. The homogenized mixture is then diluted in a further mixing and homogenization step, with component B and optionally C to F, to the solids content necessary for the printing and worked with the dissolver or other mixing apparatus into a homogeneous mixture, for example by mixing for 10 minutes at rotational speeds of up to 3000/min in the SpeedMixer DAC400FVZ (from Hauschild & Co. KG, Hamm, D).

Wax-containing slips are preferably printed at a temperature in the range of from 60° C. to 140° C., particularly preferably from 70° C. to 120° C. and quite particularly preferably from 80° C. to 100° C., by which is meant the temperature in the print nozzle. Immediately after the drops strike the construction platform or the already printed layers, the printed drops cure, as the wax portion contained in the slip solidifies. The temperature of the construction platform in this case preferably lies in the temperature range of from 20° C. to 100° C., particularly preferably from 20° C. to 70° C., quite particularly preferably from 20° C. to 40° C. The curing procedure can be controlled by the difference in temperature between printing temperature and temperature of the platform. In addition, each layer is cured by polymerization and the shaped body solidified over the whole volume due to the resultant polymer network. The curing by polymerization can take place in layers or preferably parallel to the printing. In the second case, each drop is cured immediately after the printing, for example by irradiation with light.

Wax-free slips are preferably printed at a temperature in the range of from 40° C. to 140° C., particularly preferably from 50° C. to 120° C. and quite particularly preferably from 60° C. to 110° C. Each drop is preferably cured by polymerization after the drops strike the construction platform or already printed layers. Alternatively, the curing can take place in layers. The temperature of the construction platform in this case preferably lies in the range of from 20° C. to 100° C., particularly preferably from 20° C. to 70° C., quite particularly preferably from 20° C. to 40° C.

Once the printing process is concluded, the support material is optionally mechanically or chemically removed. The shaped bodies are then chemically and/or thermally debindered and finally sintered.

The debindering (d) serves to remove the temporary binding agent and possibly present waxes and additives from the green body. The removal of the support material particularly preferably takes place together with the debindering of the green compact. The white body is produced from the green compact through the debindering.

Support material and binding agent can preferably be removed thermally e.g. by melting, evaporation or combustion processes. For this, the green compact is preferably heated to a temperature of from 50° C. to 600° C., particularly preferably from 60° C. to 500° C. and quite particularly preferably from 150° C. to 500° C. The heating preferably takes place for a period of from 3 h to 7 h.

The white body obtained is sintered in step (e) to a dense ceramic shaped body. The sintering of the white bodies of Y-TZP and ATZ ceramics takes place in the sintering furnace, preferably at temperatures between 1200° C. and 1700° C., preferably between 1300° C. and 1600° C., particularly preferably between 1350° C. and 1500° C. White bodies of glass or glass ceramic powders are preferably sintered at temperatures in the range of from 500° C. to 1200° C., particularly preferably between 600° C. and 1000° C., particularly preferably between 700° C. and 900° C. The sintering time is preferably 2 h to 6 h, particularly preferably 4 h to 5.5 h.

The sintering (e) is a high-temperature process which serves to solidify the shaped body as pore-free as possible. In this case, material rearrangement and grain growth processes take place (in the case of oxide ceramics predominantly by diffusion), through which the individual ceramic particles “move” towards one another and form a dense, solid and pore-free structure. The sintering procedure leads to a compaction of preferably >98%, preferably >98.5% and quite particularly preferably >99% of the theoretical density of the ceramic.

In a particularly preferred embodiment, the debindering and sintering takes place in a one-stage process in the temperature range between 20° C. and 1700° C., preferably between 20° C. and 1600° C., particularly preferably between 20° C. and 1500° C. The duration of the one-stage thermal process amounts to 2 h to 12 h, preferably to 4 h to 10 h, particularly preferably to 6 h to 10 h.

Due to the debindering and sintering, the shaped body experiences a volume contraction which varies depending on the degree of filling. This volume contraction is taken into account in advance by oversizing the shaped body to be printed, in order to guarantee the accuracy of fit of the debindered and sintered component. For e.g., a 36 vol.-% ink, the contraction is 64%, in other words a 90-pl drop ultimately generates a calculated volume of 32 pl in the sintered component, which is equivalent to the voxel (volumetric pixel) size of the sintered ceramic component that can be generated. The drop volume predetermines the smallest voxel size that can be generated.

The 3D inkjet printing process for ceramic slips according to the invention makes it possible to prepare individualized, three-dimensional material- and/or colour-graded ceramic green bodies which can then be densely sintered to ceramic bodies using several printheads which are supplied from reservoirs filled with differently composed, i.e., e.g., differently coloured, slips. The process according to the invention is suitable for preparing any ceramic shaped parts. A preferred application of the process is the preparation of dental restorations, such as bridges, in particular bridge frames, inlays, onlays, crowns, implants, abutments and veneers. The application of this process with a colour gradation makes it possible for the dental technician or dentist to prepare the individual colour design of the denture by means of an automated manufacture.

In the preparation of dental restorations by means of known CAD/CAM processes, the virtually designed dental frames are milled or ground from assembled blanks. These assembled blanks consist 100% of one material, most often of partially sintered Y-TZP. This Y-TZP has a breaking strength of over 900 MPa in the sintered state. These mechanical properties produce the hereby necessary minimum wall and connector thicknesses, which are preset by the material suppliers and which are taken into account in the automated preparation of the denture via the milling technique. The “connector” is the connection between crowns and/or bridge elements in the case of bridges with more than two elements, as can be seen e.g., at 8 and 9 in FIG. 4. These values are implemented in the CAD software used for the virtual design of the denture and are always reached.

According to the invention, an increased mechanical reliability of the components is achieved through the targeted strengthening of dental ceramic frames with materials of higher strength and the likelihood of their breaking is thereby reduced. On the other hand, however, the application of the process according to the invention also makes it possible to design the bridge connections more delicately, without adversely affecting the mechanical load capacity. The demands made of the aesthetics of the full ceramic denture to be manufactured can thus be increased, because a clearly improved separation between abutment crown and bridge element is now made possible.

The process according to the invention for the first time allows dental restorations which are satisfactory both aesthetically and mechanically to be prepared economically. This is achieved in that the visual and mechanical properties can be set in targeted manner by simultaneously printing several inks in different areas of the shaped body. By combining e.g. Y-TZP with ATZ, which is less translucent but has a higher mechanical load capacity, for the targeted strengthening of critical areas, restorations that are satisfactory both mechanically and visually can be prepared. The restorations are characterized in that several material properties, such as e.g., the visual and mechanical properties, gradually change in three dimensions in each case, wherein the gradients do not normally run parallel. A more delicate design of the connections, which allows a clearer separation of the individual teeth even after an optional veneering with glass ceramic veneer materials, is hereby possible in the aesthetically particularly critical front teeth area. When applying the process according to the invention in the side teeth area, which is particularly subject to mechanical stresses, a higher strength and reliability of the component is achieved without neglecting the visual properties.

The process according to the invention also comprises, according to a further embodiment, veneering the sintered shaped body, e.g. a basic structure for a dental bridge, preferably with a glass ceramic veneer material. The veneering takes place using the standard methods such as manual layering technique, pressing on or by CAD/CAM processes such as described in DE 10 2005 023 105 and corresponding US2006257823 (A1), which is hereby incorporated by reference, and DE 10 2005 023 106 and corresponding US2006257824 (A1), which is hereby incorporated by reference.

According to a particularly preferred embodiment of the process according to the invention, the veneer is prepared in the above-described manner as separate shaped body using a slip which contains glass ceramic particles as component (A). After the printing, the veneer is debindered, sintered and then bonded, for example glued, to the skeletal structure to be veneered. In this manner, the high mechanical load capacity of an oxide ceramic which is preferably used to prepare the skeletal structure can be combined with the excellent visual properties of a glass ceramic which is preferably used for the veneer. The simultaneous printing of oxide and glass ceramic is not preferred according to the invention, as the sintering of such mixtures leads to unsatisfactory results.

The preparation of a complete bridge structure of ATZ ceramic is likewise possible, but ATZ ceramics have a lower translucence compared with Y-TZP, with the result that such ceramics are less preferred for the front teeth area on aesthetic grounds.

For the preparation of a shaped body, a model of the spatial distribution of the two or more slips in the shaped body is created and then the two or more slips are dispensed at each point (x,y,z) of the space in the manner predetermined by the spatial distribution. This model can be a three-dimensional computer model, i.e. a data set or a map, whereby a particular composition of one or more slips is allocated to each point (x,y,z) or each voxel. This data set or this map is used to control the process according to the invention, i.e. the shaped body is generated computer-controlled e.g. on the basis of a three-dimensional computer model of the shaped body.

For the preparation of a graded dental ceramic denture by means of 3D printing processes, for example the situation in the mouth is first digitally recorded using a scan on a plaster model or by means of an interoral scan. In the case of the interoral recording of the situation in the mouth, to check the fit, a master model is also preferably generated with the help of an automated manufacturing technology (by milling, stereolithography, or inkjet printing). Using the digital 3D scan data, the bridge frame to be generated is designed with CAD software. The design of the bridge frame takes place here according to the material-specific presets in respect of the numerical compensation of the sintering shrinkage, the minimum wall and connector thicknesses.

The output format of the designed bridge frame is a data format to which additional attributes such as e.g. colour information can be allocated (e.g. IGES format, Nurbs). Before this is sent to the printer, it is “sliced”, i.e. the three-dimensional virtual design is “cut” into discs. The height of the respective disc corresponds to the layer height during the construction or printing process, the lateral extents corresponding to the respective lateral extents of the designed component in the respective position in z direction. The bridge is now constructed in layers by successive printing of the individual layers (discs) one on top of another. The thus-obtained green body is then, as described, debindered and sintered.

### Example 1

### Wax-Containing Slip Composition

Two different slips were prepared by mixing the components given in the following table. These slips are suitable for joint use in the process according to the invention.

| | vol.-% | wt.-% |
|---|---|---|
| Components slip A | | |
| Y-TZP¹⁾ | 34.00 vol.-% | 76.84 wt.-% |
| Paraffin wax³⁾ | 39.77 vol.-% | 13.59 wt.-% |
| Hypermer LP1⁴⁾ | 3.22 vol.-% | 1.08 wt.-% |
| Octadecene | 1.91 vol.-% | 0.56 wt.-% |
| PPG 400 DA⁵⁾ | 16.75 vol.-% | 6.22 wt.-% |
| DCP⁶⁾ | 2.01 vol.-% | 0.80 wt.-% |
| SR202³⁾ | 1.99 vol.-% | 0.80 wt.-% |
| Irgacure 184⁸⁾ | 0.24 vol.-% | 0.08 wt.-% |
| Irgacure 819⁹⁾ | 0.12 vol.-% | 0.04 wt.-% |
| TEMPO¹⁰⁾ | 0.002 vol.-% | 0.001 wt.-% |
| Components slip B | | |
| Y-TZP¹⁾ | 25.83 vol.-% | 62.37 wt.-% |
| Al2O3²⁾ | 8.17 vol.-% | 12.89 wt.-% |
| Paraffin wax³⁾ | 39.54 vol.-% | 14.44 wt.-% |
| Hypermer LP1⁴⁾ | 3.46 vol.-% | 1.23 wt.-% |
| Octadecene | 1.91 vol.-% | 0.60 wt.-% |
| PPG 400 DA⁵⁾ | 16.65 vol.-% | 6.60 wt.-% |
| DCP⁶⁾ | 2.06 vol.-% | 0.88 wt.-% |
| SR202⁷⁾ | 2.04 vol.-% | 0.88 wt.-% |
| Irgacure 184⁸⁾ | 0.23 vol.-% | 0.08 wt.-% |
| Irgacure 819⁹⁾ | 0.11 vol.-% | 0.04 wt.-% |
| TEMPO¹⁰⁾ | 0.002 vol.-% | 0.001 wt.-% |

Key:
¹⁾TZ-3YS-E (commercial grade) from Tosoh Corporation, Tokyo, JP (ZrO₂ stabilized with Y₂O₃, primary particle size 300-350 nm)
²⁾TM-DAR from Taimei Chemicals CO. LTD. Tokyo, JP (α-Al₂O₃ > 99.99%, primary particle size 100 nm)
³⁾Melting point 54-56° C., viscosity (at 80° C. and a shear rate of 1000 s−1) 3-4 mPa · s (Siliplast; Zschimmer & Schwarz, Lahnstein, DE; contains a total of approximately 0.5% emulsifier)
⁴⁾Dispersion auxiliary based on a medium-chain polyester (Uniqema, GB.)
⁵⁾Polypropylene glycol-400-diacrylate
⁶⁾Tricyclodecane dimethanol dimethacrylate
⁷⁾Diethylene glycol dimethacrylate
⁸⁾1-Hydroxycyclohexyl phenyl ketone
⁹⁾Phosphine oxides, phenylbis (2,4,6-trimethylbenzoyl)
¹⁰⁾2,2,6,6-Tetramethylpiperidinyloxyl

### Example 2

### Wax-Free Slip Composition

Two different slips were prepared by mixing the components given in the following table. These slips are suitable for joint use in the process according to the invention.

| | vol.-% | wt.-% |
|---|---|---|
| Components slip C | | |
| Y-TZP¹⁾ | 34.00 vol.-% | 75.96 wt.-% |
| Disperbyk 111¹¹⁾ | 3.24 vol.-% | 1.07 wt.-% |
| PPG200¹²⁾ | 17.59 vol.-% | 6.46 wt.-% |
| Octadecene | 1.92 vol.-% | 0.55 wt.-% |
| PPG 400 DA⁵⁾ | 38.32 vol.-% | 14.06 wt.-% |
| DCP⁶⁾ | 2.12 vol.-% | 0.83 wt.-% |
| SR202⁷⁾ | 2.10 vol.-% | 0.83 wt.-% |
| Irgacure 184⁸⁾ | 0.48 vol.-% | 0.16 wt.-% |
| Irgacure 819⁹⁾ | 0.24 vol.-% | 0.08 wt.-% |
| TEMPO¹⁰⁾ | 0.005 vol.-% | 0.002 wt.-% |
| Components slip D | | |
| Y-TZP¹⁾ | 25.82 vol.-% | 61.59 wt.-% |
| Al₂O₃²⁾ | 8.18 vol.-% | 12.76 wt.-% |
| Disperbyk 111¹¹⁾ | 3.44 vol.-% | 1.21 wt.-% |
| PPG200¹²⁾ | 22.18 vol.-% | 8.69 wt.-% |
| Octadecene | 1.90 vol.-% | 0.59 wt.-% |
| PPG 400 DA⁵⁾ | 33.57 vol.-% | 13.15 wt.-% |
| DCP⁶⁾ | 2.15 vol.-% | 0.90 wt.-% |
| SR202⁷⁾ | 2.12 vol.-% | 0.90 wt.-% |
| Irgacure 184⁸⁾ | 0.42 vol.-% | 0.15 wt.-% |
| Irgacure 819⁹⁾ | 0.21 vol.-% | 0.07 wt.-% |
| TEMPO¹⁰⁾ | 0.004 vol.-% | 0.002 wt.-% |

Key:
¹¹⁾Dispersion auxiliary, copolymer with acid groups (Byk Chemie, D)
¹²⁾Polypropylene glycol 200 (see example 1 for the others)

### Example 3

### Preparation of a Shaped Body

Ink A from example 1 was printed under the following parameters in piezo DoD multi-nozzle printheads (E1 GEN3, from Ricoh, Simi Valley, Calif., USA):

Printing parameters

| Reservoir | Printhead | | | Negative |
|---|---|---|---|---|
| temperature | temperature | Frequency | Voltage in | pressure |
| in ° C. | in ° C. | in kHz | volts | in mbar |
| 90 | 90 | 10 | 37 | 10 |

The green body was then debindered and sintered under the following conditions:

Debindering parameters (Linn debindering furnace):

| Starting | Target | | |
|---|---|---|---|
| temperature | temperature | Heating/cooling | Holding |
| in ° C. | in ° C. | rate in K/min | time in min |
| 20 | 180 | 10 | |
| 180 | 250 | 0.5 | |
| 250 | 500 | 5 | |
| 500 | | | 60 |
| 500 | 20 | 10 | |

Total duration: 5 h 14 min

Sintering parameters (Nabertherm sintering furnace):

| Starting | Target | | |
|---|---|---|---|
| temperature | temperature | Heating/cooling | Holding |
| in ° C. | in ° C. | rate in K/min | time in min |
| 20 | 1400 | 5 | |
| 1400 | | | 120 |
| 1400 | 20 | 10 | |

Total duration: 8 h 54 min

Alternatively, the debindering and sintering were carried out in one process step under the following conditions:

Debindering and sintering parameters
(Nabertherm sintering furnace):

| Starting | Target | | |
|---|---|---|---|
| temperature | temperature | Heating/cooling | Holding |
| in ° C. | in ° C. | rate in K/min | time in min |
| 20 | 180 | 10 | |
| 180 | 250 | 1 | |
| 250 | 500 | 5 | |
| 500 | | | 120 |
| 500 | 1400 | 5 | |
| 1400 | | | 60 |
| 1400 | 20 | 10 | |

Total duration: 10 h 34 min

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed is:

1. Process for the generative preparation of a shaped body, in which
(a) ceramic slips are applied in layers to a support and cured,
(b) a further layer is applied to the cured layer and cured,
(c) step (b) is repeated until a body with the desired geometric shape is obtained,
(d) the body is then subjected to a chemical treatment or a heat treatment to remove the binding agent, and
(e) the body from step (d) is sintered,
wherein at least two differently composed ceramic slips are used to prepare the shaped body,
wherein the ceramic slips are applied such that the relative proportions of the slips are controlled dependent on position, with the result that the applied relative proportions of the slips within a layer vary along at least one direction in the layer plane in a predeterminable manner and wherein the application pattern for the slips can vary from layer to layer.

2. Process according to claim 1, in which in steps (a) and (b) a support material is applied together with the ceramic slip or subsequent to these steps.

3. Process according to claim 1, in which the ceramic slips and optionally the support material are applied in layers by an inkjet printing process.

4. Process according to claim 1, in which, in steps (a) and (b), ceramics slips comprise first and second slips and comprise
(A) 25 to 55 vol.-% ceramic particles and
(B) 45 to 75 vol.-% radically polymerizable binding agent, and/or slips which contain
(A) 25 to 55 vol.-% ceramic particles,
(B) 6 to 50 vol.-% radically polymerizable binding agent and
(C) 25 to 69 vol.-% wax.

5. Process according to claim 4, in which the first and/or second slip additionally contains an initiator for the radical polymerization and the layers are cured by irradiation with light.

6. Process according to claim 1, in which at least one first slip which contains ceramic particles based on ZrO₂ and at least one second slip which contains ceramic particles based on Al₂O₃ are used.

7. Process according to claim 6, in which at least one first slip based on Y-TZP (basic slip) and at least one second slip (secondary slip) which contains 20 to 100 wt.-% Al₂O₃ and 0 to 80 wt.-% Y-TZP, preferably 40-60 wt.-% Al₂O₃ and 60-40 wt.-% ZrO₂, particularly preferably 20 wt.-% Al₂O₃ and 80 wt.-% Y-TZP, are used.

8. Process according to one of claim 1, in which slips based on glass ceramic particles are used.

9. Process according to claim 8, in which slips based on leucite, apatite and/or lithium disilicate glass ceramic particles are used.

10. Process according to claim 1, in which at least two slips are used which contain different coloured ceramic particles.

11. Process according to claim 1, in which the shaped body is veneered.

12. Process according to claim 1, in which the shaped body is a dental restoration.

13. Process according to claim 12, in which the dental restoration comprises a bridge, a bridge frame, inlay, onlay, a crown, an implant, abutment or a veneer.

14. Process according to claim 1, wherein the shaped body is generated on the basis of a three-dimensional computer model of the shaped body.

15. Shaped body prepared by the process of claim 1.

16. System comprising an inkjet printer which is suitable for printing ceramic slips and at least two different ceramic slips.
